(19) United States
(12) Patent Application Publication
(10) Pub. No.: US 2021/0140273 A1
(43) Pub. Date: May 13, 2021

(54) TORSIONAL FLOW INDUCER

(71) Applicant: Jeffrey Charles SAPONJA, Invermere (CA)

(72) Inventors: Jeffrey Charles SAPONJA, Calgary (CA); Robbie Singh HARI, Calgary (CA); Scott KRELL, Calgary (CA); Sean DAVID, Calgary (CA)

(21) Appl. No.: 17/093,560

(22) Filed: Nov. 9, 2020

Related U.S. Application Data
(60) Provisional application No. 62/933,080, filed on Nov. 8, 2019.
(60) Provisional application No. 63/105,031, filed on Oct. 23, 2020.

(51) Int. Cl. E21B 34/14; E21B 34/08; F15D 1/06

(52) U.S. Cl. CPC E21B 34/142; E21B 2200/04; F15D 1/065; E21B 34/08

(57) ABSTRACT

A system for producing reservoir fluids from a reservoir disposed within a subterranean formation is disclosed. The system includes a valve having a valve body that defines a flow communicator and a seat. The system further includes a closure member. The system further includes a torsional flow inducer, disposed downhole relative to the seat, and defining a contoured surface. The closure member, the valve seat, the flow communicator, and the contoured surface are co-operatively configured such that, while the closure member is unseated from the valve seat, and fluid flow is being conducted through the flow communicator, the fluid flow is conducted across the contoured surface with effect that torsional flow is induced by the contoured surface.

### FIELD

The present disclosure relates to producing reservoir fluids while mitigating damage to a downhole valve, such as a valve of a downhole pump.

### BACKGROUND

Damage to downhole pumps, for example, the valve of the pump, is a problem encountered while producing reservoir fluids from a reservoir disposed within a subterranean formation. While the reservoir fluids are flowing through the valve, the reservoir fluids cause certain components of the valve, such as a wellbore obstruction device (e.g. a ball), to displace, which may cause damage to the valve, and thus, cause damage to the pump.

### SUMMARY

In one aspect, there is provided a torsional flow-inducing adapter configured for connection to a downhole valve disposed within a wellbore, wherein the downhole valve includes:

a valve body defining a flow communicator and a seat; and

a closure member;

wherein:
the closure member, the flow communicator, and the seat are co-operatively configured such that, while the closure member is seated on the seat, the flow communicator is occluded by the closure member; and
the closure member, the flow communicator, and the seat are co-operatively configured such that, while the closure member is seated on the seat, the closure member is displaceable uphole relative to the seat with effect that:
(i) the closure member is unseated relative to the seat;
(ii) fluid flow is conductible through the flow communicator; and
(iii) while fluid flow is being conducted through the flow communicator, the closure member is obstructive to the conducted fluid flow, with effect that at least a portion of the conducted fluid flow is diverted past the closure member;

wherein:

the torsional flow-inducing adapter defines a contoured surface; and

the torsional flow-inducing adapter is configured to co-operate with the valve such that, while the torsional flow-inducing adapter is connected to the valve, the contoured surface is disposed downhole relative to the valve seat, such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.

In another aspect, there is provided a system for producing reservoir fluids from a reservoir disposed within a subterranean formation, the system comprising:

a valve body defining a flow communicator and a seat;

a closure member;

a torsional flow inducer, connected to the seat and disposed downhole relative to the seat, and defining a contoured surface;

wherein:
the closure member, the flow communicator, and the seat are co-operatively configured such that, while the closure member is seated on the seat, the flow communicator is occluded by the closure member; and
the closure member, the flow communicator, and the seat are co-operatively configured such that, while the closure member is seated on the seat, the closure member is displaceable uphole relative to the seat with effect that:
(i) the closure member is unseated relative to the seat;
(ii) fluid flow is conductible through the flow communicator; and
(iii) while fluid flow is being conducted through the flow communicator, the closure member is obstructive to the conducted fluid flow, with effect that at least a portion of the conducted fluid flow is diverted past the closure member;
and
the torsional flow-inducer co-operates with the valve such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.

In another aspect, there is provided a system for producing reservoir fluids from a reservoir disposed within a subterranean formation, the system comprising:
a rod pump including a traveling valve and a standing valve, wherein the standing valve includes:
   a valve body defining a flow communicator and a seat; and
   a closure member;
and
a torsional flow inducer, disposed downhole relative to the seat, and defining a contoured surface;
wherein:
   the closure member, the flow communicator, and the seat are co-operatively configured such that, while the closure member is seated on the seat, the flow communicator is occluded by the closure member; and
   the closure member, the flow communicator, and the seat are co-operatively configured such that, while the closure member is seated on the seat, the closure member is displaceable uphole relative to the seat with effect that:
   (iv) the closure member is unseated relative to the seat;
   (v) fluid flow is conductible through the flow communicator; and
   (vi) while fluid flow is being conducted through the flow communicator, the closure member is obstructive to the conducted fluid flow, with effect that at least a portion of the conducted fluid flow is diverted past the closure member;
   and
      the torsional flow inducer co-operates with the standing valve such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.

In another aspect, there is provided a method of coupling a torsional flow inducing adapter to a rod pump disposed within a wellbore, wherein the rod pump includes a standing valve and a travelling valve, comprising:

retrieving the rod pump from a wellbore;
for at least one of the standing valve and the travelling valve, connecting a respective torsional flow inducing adapter to each one of the at least one of the standing valve and the travelling valve such that a modified rod pump is obtained including at least one torsional flow inducing adapter, wherein each one of the at least one torsional flow inducing adapter, independently, is disposed in flow communication with a respective one of the standing valve and the travelling valve, such that for each one of the at least one torsional flow inducing adapter, independently, the torsional flow inducing adapter is configured for inducing torsional flow to reservoir fluid being conducted, via the torsional flow inducing adapter, to the respective one of the standing valve and the travelling valve; and
deploying the modified rod pump within the wellbore.

Other aspects will be apparent from the description and drawings provided herein.

### BRIEF DESCRIPTION OF DRAWINGS

In the figures, which illustrate example embodiments,

FIG. 1 is a schematic illustration of an embodiment of a system for producing reservoir fluids from a reservoir disposed within a subterranean formation;

FIG. 2A is a schematic illustration of an embodiment of the plunger pump of FIG. 2A, with the standing valve, traveling valve, pump cavity, and conveyer co-operatively configured in a downhole-disposed movement reversal configuration;

FIG. 2B is a schematic illustration of an embodiment of a plunger pump of the system of FIG. 1, with the standing valve, traveling valve, pump cavity, and conveyer co-operatively configured in a pump cavity-filling configuration;

FIG. 2C is a schematic illustration of an embodiment of the plunger pump of FIG. 2A, with the standing valve, traveling valve, pump cavity, and conveyer co-operatively configured in an uphole-disposed movement reversal configuration;

FIG. 2D is a schematic illustration of an embodiment of the plunger pump of FIG. 2A, with the standing valve, traveling valve, pump cavity, and conveyer co-operatively configured in a pump cavity-evacuation configuration;

FIG. 3 is a sectional side elevation view of a section of a torsional flow-inducing adapter of the system of FIG. 1;

FIG. 4 is a sectional elevation view taken from one end of the torsional flow-inducing adapter of FIG. 3;

FIG. 5 is a side elevation view of an embodiment of a torsional flow-inducing adapter;

FIG. 6 is a top view of the torsional flow-inducing adapter of FIG. 5;

FIG. 7 is a sectional side elevation view of the torsional flow-inducing adapter of FIG. 5 along line A-A as depicted in FIG. 5;

FIG. 8 is a schematic illustration of the torsional flow-inducing adapter of FIG. 5;

FIG. 9 is a schematic illustration of the torsional flow-inducing adapter of FIG. 5 connected to a standing valve;

FIG. 10 is a top view of an embodiment of a strainer nipple;

FIG. 11 is a sectional side elevation view of the strainer nipple of FIG. 10 along line C-C as depicted in FIG. 10;

FIG. 12 is a top view of an embodiment of a torsional flow-inducing adapter, with a torsional flow-inducing insert disposed in the strainer nipple of FIG. 10;

FIG. 13 is a sectional side elevation view of the torsional flow-inducing adapter of FIG. 12 along line B-B as depicted in FIG. 12;

FIG. 14 is a schematic illustration of an embodiment of two strainer nipples;

FIG. 15 is a schematic illustration of an embodiment of a torsional flow-inducing insert;

FIG. 16 is a side elevation view of an embodiment of a strainer nipple;

FIG. 17 is a top view of an embodiment of a torsional flow-inducing insert;

FIG. 18 is a side elevation view of the torsional flow-inducing insert of FIG. 17;

FIG. 19 is a top view of the torsional flow-inducing insert of FIG. 15 received in the strainer nipple of FIG. 16;

FIG. 20 is a schematic illustration of a torsional flow-inducing adapter disposed upstream of a float collar;

FIG. 21 is a schematic illustration of a torsional flow-inducing adapter disposed upstream of a float shoe;

FIG. 22 is a schematic illustration of a torsional flow-inducing adapter disposed upstream of a standing valve assembly comprising two standing valves;

FIG. 23 is a schematic illustration of a torsional flow-inducing adapter disposed between two standing valves of a standing valve assembly;

FIG. 24 is a schematic illustration of a torsional flow-inducing adapter disposed upstream of a traveling valve assembly comprising two traveling valves;

FIG. 25 is a schematic illustration of a torsional flow-inducing adapter disposed between two traveling valves of a traveling valve assembly.

### DETAILED DESCRIPTION

As used herein, the terms “up”, “upward”, “upper”, or “uphole”, mean, relativistically, in closer proximity to the surface 106 and further away from the bottom of the wellbore, when measured along the longitudinal axis of the wellbore 102. The terms “down”, “downward”, “lower”, or “downhole” mean, relativistically, further away from the surface 106 and in closer proximity to the bottom of the wellbore 102, when measured along the longitudinal axis of the wellbore 102.

Referring to FIG. 1, there are provided a system 10, for producing hydrocarbon material from a reservoir 104, such as an oil reservoir, within a subterranean formation 100, when reservoir pressure within the oil reservoir is insufficient to conduct hydrocarbon material to the surface 106 through a wellbore 102.

The wellbore 102 can be straight, curved, or branched. The wellbore 102 can have various wellbore portions. A wellbore portion is an axial length of a wellbore 102. A wellbore portion can be characterized as “vertical” or “horizontal” even though the actual axial orientation can vary from true vertical or true horizontal, and even though the axial path can tend to “corkscrew” or otherwise vary. The term “horizontal”, when used to describe a wellbore portion, refers to a horizontal or highly deviated wellbore portion as understood in the art, such as, for example, a wellbore portion having a longitudinal axis that is between about 70 and about 110 degrees from vertical. The term “vertical”, when used to describe a wellbore portion, refers to a vertical or highly deviated vertical portion as understood in the art, such as, for example, a wellbore portion having a longitudinal axis that is less than about 20 degrees from the vertical.

“Reservoir fluid” is fluid that is contained within the reservoir 104. Reservoir fluid may be liquid material, gaseous material, or a mixture of liquid material and gaseous material. In some embodiments, for example, the reservoir fluid includes water and hydrocarbons, such as oil, natural gas condensates, or any combination thereof.

Fluids may be injected into the oil reservoir through the wellbore to effect stimulation of the reservoir fluid. For example, such fluid injection is effected during hydraulic fracturing, water flooding, water disposal, gas floods, gas disposal (including carbon dioxide sequestration), steam-assisted gravity drainage (“SAGD”) or cyclic steam stimulation (“CSS”). In some embodiments, for example, the same wellbore is utilized for both stimulation and production operations, such as for hydraulically fractured formations or for formations subjected to CSS. In some embodiments, for example, different wellbores are used, such as for formations subjected to SAGD, or formations subjected to waterflooding.

A wellbore string 113 is employed within the wellbore 102 for stabilizing the subterranean formation 100. In some embodiments, for example, the wellbore string 113 also contributes to effecting fluidic isolation of one zone within the subterranean formation 100 from another zone within the subterranean formation 100.

The fluid productive portion of the wellbore 102 may be completed either as a cased-hole completion or an open-hole completion.

A cased-hole completion involves running wellbore casing down into the wellbore through the production zone. In this respect, in the cased-hole completion, the wellbore string 113 includes wellbore casing.

The annular region between the deployed wellbore casing and the reservoir 104 may be filled with cement for effecting zonal isolation (see below). The cement is disposed between the wellbore casing and the oil reservoir for the purpose of effecting isolation, or substantial isolation, of one or more zones of the oil reservoir from fluids disposed in another zone of the oil reservoir. Such fluids include reservoir fluid being produced from another zone of the oil reservoir (in some embodiments, for example, such reservoir fluid being flowed through a production tubing string disposed within and extending through the wellbore casing to the surface), or injected fluids such as water, gas (including carbon dioxide), or stimulations fluids such as fracturing fluid or acid. In this respect, in some embodiments, for example, the cement is provided for effecting sealing, or substantial sealing, of flow communication between one or more zones of the oil reservoir and one or more others zones of the oil reservoir (for example, such as a zone that is being produced). By effecting the sealing, or substantial sealing, of such flow communication, isolation, or substantial isolation, of one or more zones of the oil reservoir, from another subterranean zone (such as a producing formation), is achieved. Such isolation or substantial isolation is desirable, for example, for mitigating contamination of a water table within the oil reservoir by the reservoir fluid (e.g. oil, gas, salt water, or combinations thereof) being produced, or the above-described injected fluids.

In some embodiments, for example, the cement is disposed as a sheath within an annular region between the wellbore casing and the oil reservoir. In some embodiments, for example, the cement is bonded to both of the production casing and the oil reservoir.

In some embodiments, for example, the cement also provides one or more of the following functions: (a) strengthens and reinforces the structural integrity of the wellbore, (b) prevents, or substantially prevents, produced reservoir fluid of one zone from being diluted by water from other zones. (c) mitigates corrosion of the wellbore casing, (d) at least contributes to the support of the wellbore casing, and e) allows for segmentation for stimulation and fluid inflow control purposes.

The cement is introduced to an annular region between the wellbore casing and the reservoir 104 after the subject wellbore casing has been run into the wellbore. This operation is known as “cementing”.

In some embodiments, for example, the wellbore casing includes one or more casing strings, each of which is positioned within the well bore, having one end extending from the well head. In some embodiments, for example, each casing string is defined by jointed segments of pipe. The jointed segments of pipe typically have threaded connections.

Typically, a wellbore contains multiple intervals of concentric casing strings, successively deployed within the previously run casing. With the exception of a liner string, casing strings typically run back up to the surface 106. Typically, casing string sizes are intentionally minimized to minimize costs during well construction. Generally, smaller casing sizes make production and artificial lofting more challenging.

For wells that are used for producing reservoir fluid, few of these actually produce through wellbore casing. This is because producing fluids can corrode steel or form undesirable deposits (for example, scales, asphaltenes or paraffin waxes) and the larger diameter can make flow unstable. In this respect, a production string is usually installed inside the last casing string. The production string is provided to conduct reservoir fluid, received within the wellbore, to the wellhead 116. In some embodiments, for example, the annular region between the last casing string and the production tubing string may be sealed at the bottom by a packer.

To facilitate flow communication between the reservoir and the wellbore, the wellbore casing may be perforated, or otherwise include per-existing ports (which may be selectively openable, such as, for example, by shifting a sleeve), to provide a fluid passage for enabling flow of reservoir fluid from the reservoir to the wellbore.

In some embodiments, for example, the wellbore casing is set short of total depth. Hanging off from the bottom of the wellbore casing, with a liner hanger or packer, is a liner string. The liner string can be made from the same material as the casing string, but, unlike the casing string, the liner string does not extend back to the wellhead 116. Cement may be provided within the annular region between the liner string and the oil reservoir for effecting zonal isolation (see below), but is not in all cases. In some embodiments, for example, this liner is perforated to effect flow communication between the reservoir and the wellbore. In this respect, in some embodiments, for example, the liner string can also be a screen or is slotted. In some embodiments, for example, the production tubing string may be engaged or stung into the liner string, thereby providing a fluid passage for conducting the produced reservoir fluid to the wellhead 116. In some embodiments, for example, no cemented liner is installed, and this is called an open hole completion or uncemented casing completion.

An open-hole completion is effected by drilling down to the top of the producing formation, and then lining the wellbore (such as, for example, with a wellbore string 113). The wellbore is then drilled through the producing formation, and the bottom of the wellbore is left open (i.e. uncased), to effect flow communication between the reservoir and the wellbore. Open-hole completion techniques include bare foot completions, pre-drilled and pre-slotted liners, and open-hole sand control techniques such as stand-alone screens, open hole gravel packs and open hole expandable screens. Packers and casing can segment the open hole into separate intervals and ported subs can be used to effect flow communication between the reservoir and the wellbore.

Referring to FIG. 1, a system 10 is provided for effecting production of reservoir fluid from the reservoir 104 of the subterranean formation 100.

In some embodiments, for example, the system 10 includes a sucker rod pumping system 150. The sucker rod pumping system 150 includes a sucker rod pump 300 and a reservoir fluid-supplying conductor 202.

The reservoir fluid-supplying conductor 202 is emplaced within the wellbore 102. The reservoir fluid-supplying conductor 202 defines a flow receiving communicator 204, and extends from the flow receiving communicator 204 to the surface 106. The reservoir fluid-supplying conductor 202 is configured for conducting reservoir fluid, received by the flow receiving communicator 314, to the surface 106. Reservoir fluid, which is conducted into the wellbore 102 from the reservoir 104, is receivable by the flow receiving communicator 204.

The sucker rod pump 300 and the reservoir fluid-supplying conductor 202 are co-operatively configured such that reciprocating movement of the sucker rod pumping system 150 induces flow of reservoir fluid, via the reservoir fluid-supplying conductor 202, from the reservoir 104 to the surface 106, and thereby effects production of the reservoir fluid at the surface. It is understood that the reservoir fluid being conducted uphole via the conductor 202, may be additionally energized by supplemental means, such as, for example, gas-lift.

In some embodiments, for example, the sucker rod pump 300 includes a conveyor 302, such as a sucker rod or a rod string, which is connected to the surface equipment of the sucker rod pumping system 150. In some embodiments, for example, the surface equipment includes a prime mover (e.g. an internal combustion engine or a motor), a crank arm, and a beam. The prime mover rotates the crank arm, and the rotational movement of the crank arm is converted to reciprocal longitudinal movement through the beam. The beam is attached to a polished rod by cables hung from a horsehead at the end of the beam. The polished rod passes through a stuffing box and is attached to the conveyor 302. Accordingly, the surface equipment effects reciprocating longitudinal movement of the conveyor 302, and further defines the upper and lower displacement limits of the conveyor 302. Reservoir fluid is produced to the surface in response to reciprocating longitudinal movement of the sucker rod 302 by the pump jack.

FIGS. 2A to 2D depict an example embodiment of the sucker rod pump 300. In some embodiments, for example, the sucker rod pump 300 further includes a plunger 308, and the plunger includes a traveling valve 306. The plunger 308 is connected to the conveyor 302 such that the plunger 308 (and, therefore, the traveling valve 306) displaces with the conveyor 302. The pump 300 further includes a barrel 304 that includes a standing valve 310. The barrel 304 is configured to receive the plunger 308 and, in this respect, the plunger 308 is moveable relative to the barrel 304 such that the traveling valve 306 is displaceable, relative to the standing valve 310, for positioning relative to the standing valve 310 within a range of positions uphole of the standing valve 310. A pump cavity 312 is defined between the standing valve 310 and the traveling valve 306, and its volume is determinable based on the positioning of the traveling valve 306 relative to the standing valve 310.

In some embodiments, for example, as depicted in FIG. 9, the barrel 304 includes a hold down 318, and the reservoir fluid supplying conductor 202 includes a seating nipple 210. The hold down 318 and the seating nipple 210 are co-operatively configured for effecting mounting of the barrel to the reservoir fluid supplying conductor such that the pump 300 becomes emplaced within the reservoir fluid supplying conductor 202. In some embodiments, for example, the mounting is with effect that the standing valve 310 remains stationary as the sucker rod 302 is displaced. To emplace the pump 300 in the reservoir fluid supplying conductor 202, the pump 300 is lowered, from the surface, into the reservoir fluid supplying conductor 202 to effect engagement of the hold down 318 and the seating nipple 210, such that the barrel 304 is connected to the reservoir fluid supplying conductor 202.

In some embodiments, for example, the traveling valve 306 defines a flow communicator 3062 and a seat 3064. As depicted in FIG. 2A, the traveling valve 306 includes a closure member 3066. In some embodiments, for example, the closure member 3066, the flow communicator 3062, and the seat 3064 are co-operatively configured such that, while the closure member 3066 is seated on the seat 3064, the flow communicator 3062 is occluded by the closure member 3066. In some embodiments, for example, the occlusion is with effect that the flow communicator 3062 is closed.

In some embodiments, for example, the closure member 3066, the flow communicator 3062, and the seat 3064 are further co-operatively configured such that, while the closure member 3066 is unseated (i.e. spaced apart) relative to the seat 3064, fluid flow is conductible through the flow communicator 3062, and while fluid flow is being conducted through the flow communicator 3062, the closure member 3066 is obstructive to the conducted fluid flow, with effect that at least a portion of the conducted fluid flow is diverted past the closure member 3066.

In some embodiments, for example, the closure member 3066, the flow communicator 3062, and the seat 3064 are further co-operatively configured such that, while the closure member 3066 is seated on the seat 3064 such that the flow communicator 3062 is being occluded by the closure member 3066, unseating of the closure member 3066 is effectible in response to displacement of the closure member 3066, relative to the seat 3064, along an axis that is parallel to a central axis of the flow communicator 3062.

In some embodiments, for example, the closure member 3066, the flow communicator 3062, and the seat 3064 are further co-operatively configured such that, while the closure member 3066 is seated on the seat 3064 such that the flow communicator 3062 is being occluded by the closure member 3066, unseating of the closure member 3066 is effectible in response to displacement of the closure member 3066, relative to the seat 3064, along an axis that is perpendicular to the plane within which the flow communicator 3062 is disposed.

In some embodiments, for example, the closure member 3066 has an outermost surface, and at least a portion of the outermost surface is defined by an arcuate profile, wherein the at least a portion of the outermost surface, defined by an arcuate profile, is an arcuate profile-defining outermost surface. In this respect, in such embodiments, for example, the seat 3064 defines a seating surface 3064A, and at least a portion of the seating surface 3064A has an arcuate profile. The at least a portion of the seating surface 3064A having the arcuate profile is complementary to the arcuate profile-defining outermost surface of the closure member 3066. In this respect, the at least a portion of the seating surface 3064A, having the arcuate profile, receives seating of the arcuate profile-defining outermost surface of the closure member 3066, while the closure member 3066 is seated on the seat 3064.

In some of these embodiments, for example, the closure member 3066 is a ball. In some embodiments, for example, the closure member 3066 is a plug. In some embodiments, for example, the closure member 3066 is a dart. In some embodiments, for example, the closure member 3066 is a poppet (such that the traveling valve 306 is a poppet valve).

In some embodiments, for example, the standing valve 310 defines a flow communicator 3102 and a seat 3104. As depicted in FIG. 2A, the standing valve 310 includes a closure member 3106. In some embodiments, for example, the closure member 3106, the flow communicator 3102, and the seat 3104 are co-operatively configured such that, while the closure member 3106 is seated on the seat 3104, the flow communicator 3102 is occluded by the closure member 3106. In some embodiments, for example, the occlusion is with effect that the flow communicator 3102 is closed.

In some embodiments, for example, the closure member 3106, the flow communicator 3102, and the seat 3104 are further co-operatively configured such that, while the closure member 3106 is unseated (e.g. spaced apart) relative to the seat 3104, fluid flow is conductible through the flow communicator 3102, and while fluid flow is being conducted through the flow communicator 3102, the closure member 3106 is obstructive to the conducted fluid flow, with effect that at least a portion of the conducted fluid flow is diverted past the closure member 3106.

In some embodiments, for example, the closure member 3106, the flow communicator 3102, and the seat 3104 are further co-operatively configured such that, while the closure member 3106 is seated on the seat 3104 such that the flow communicator 3102 is being occluded by the closure member 3106, unseating of the closure member 3106 is effectible in response to displacement of the closure member 3106, relative to the seat 3104, along an axis that is parallel to a central axis of the flow communicator 3102.

In some embodiments, for example, the closure member 3106, the flow communicator 3102, and the seat 3104 are further co-operatively configured such that, while the closure member 3106 is seated on the seat 3104 such that the flow communicator 3102 is being occluded by the closure member 3106, unseating of the closure member 3106 is effectible in response to displacement of the closure member 3106, relative to the seat 3104, along an axis that is perpendicular to the plane within which the flow communicator 3102 is disposed.

In some embodiments, for example, the closure member 3106 has an outermost surface, and at least a portion of the outermost surface is defined by an arcuate profile, wherein the at least a portion of the outermost surface, defined by an arcuate profile, is an arcuate profile-defining outermost surface. In this respect, in such embodiments, for example, the seat 3104 defines a seating surface 3104A, and at least a portion of the seating surface 3104A has an arcuate profile. The at least a portion of the seating surface 3104A having the arcuate profile is complementary to the arcuate profile-defining outermost surface of the closure member 3106. In this respect, the at least a portion of the seating surface 3104A, having the arcuate profile, receives seating of the arcuate profile-defining outermost surface of the closure member 3106, while the closure member 3106 is seated on the seat 3104.

In some of these embodiments, for example, the closure member 3106 is a ball. In some embodiments, for example, the closure member 3106 is a plug. In some embodiments, for example, the closure member 3106 is a dart. In some embodiments, for example, the closure member 3106 is a poppet (such that the standing valve 310 is a poppet valve).

FIGS. 2A to 2D are schematic illustrations of different configurations of an embodiment of the sucker rod pump 300.

As depicted in FIG. 2A, the sucker rod pump 300 is configurable in a downhole-disposed movement reversal configuration. As depicted, in the downhole-disposed movement reversal configuration, the traveling valve 306 is closed and the standing valve 310 is closed.

In some embodiments, for example, the pump 300 is transitionable from the downhole-disposed movement reversal configuration (FIG. 2A) to the pump cavity-filling configuration (FIG. 2B) in response to displacement of the conveyer 302 in the uphole direction. In the pump cavity-filling configuration, the travelling valve 306 is closed and the standing valve 310 is open.

While the pump 300 is disposed in the downhole-disposed movement reversal configuration, the conveyer 302 is displaceable uphole, and, in response to the uphole displacement of the conveyor 302, the transitioning of the pump 300 from the downhole-disposed movement reversal configuration to the pump cavity-filling configuration is effected. In this respect, while the sucker rod pumping system 150 is emplaced within the wellbore 102 such that the pump 300 is disposed in the downhole-disposed movement reversal configuration, in response to the conveyer 302 being displaced in an uphole direction such that the travelling valve 306 is displaced away from the standing valve 310 with effect that volume of the pump cavity 312 is increased and pressure within the pump cavity 312 is being reduced:

a sufficiently low opening pressure is established within the pump cavity 312.

At this point, fluid pressure of fluid disposed downhole relative to, and in fluid pressure communication with, the standing valve 310, sufficiently exceeds the sufficiently low opening pressure within the pump cavity 312, such that an effective opening pressure differential is established across the closure member 3106 of the standing valve 310. In some embodiments, for example, the downhole-disposed fluid is fluid disposed within the wellbore 102, downhole relative to the flow receiving communicator 204.

In response to the effective opening pressure differential, the closure member 3106, which is seated on the seat 3104, becomes unseated from the valve seat 3104, such that the standing valve 310 becomes open, and reservoir fluid immediately downhole 314 relative to the standing valve 310 (within the reservoir fluid conductor 202) is displaced from the wellbore 102, through the stationary valve 310, and is received within the pump cavity 312, as depicted in FIG. 2B. In this respect, in some embodiments, for example, the standing valve 310 is openable in response to the effective opening pressure differential. In some embodiments, for example, the effective opening pressure differential is established in response to displacement of the conveyer 302 in the uphole direction, which effects displacement of the travelling valve 306 away from the standing valve 310 and thereby increases the volume of the pump cavity 312.

In this respect, in some embodiments, for example, the plunger 308, the traveling valve 306, the standing valve 310, and the pump cavity 312 are co-operatively configured such that, while the pump 300 is disposed in the downhole-disposed movement reversal configuration, in response to uphole displacement of the plunger 308: (i) the traveling valve 306 is urged to remain closed, and (ii) the standing valve 310 is urged to open, with effect that reservoir fluid, disposed immediately downhole relative to the standing valve 310, becomes displaced, such that the displaced reservoir fluid becomes disposed within the pump cavity 312.

While the conveyor 302 continues to be displaced in an uphole direction such that the travelling valve 306 is further displaced away from the standing valve 310, the closure member 3106 of the standing valve 310, which is unseated from the seat 3104, is urged to remain unseated from the valve seat 3104, such that the standing valve 310 remains open, and reservoir fluid within the wellbore 102 continues to be displaced from the wellbore 102, through the stationary valve 310, and is received within the pump cavity 312

Meanwhile, while the conveyer 302 is being displaced in an uphole direction, such that the traveling valve 306 is being displaced away from the standing valve 310, an effective closing pressure differential remains established across the closure member 3066 of the traveling valve 306. In this respect, fluid pressure, of fluid disposed immediately uphole relative to, and in fluid pressure communication with, the traveling valve 306, sufficiently exceeds the sufficiently low opening pressure within the pump cavity 312, such that an effective closing pressure differential is established across the closure member 3066 of the traveling valve 306. In response to the effective closing pressure differential, and, in combination with gravitational forces, the closure member 3066, which is seated on the seat 3064, is urged to remain seated on the valve seat 3064, such that the traveling valve 306 remains closed, and flow of reservoir fluid through the traveling valve 306 is prevented.

In parallel, while the pump 300 is disposed in the pump cavity-filling configuration, and the conveyor 302 is being displaced uphole, displacement of fluid, disposed uphole of the traveling valve 306 (for example, the reservoir fluid disposed in the uphole-disposed space 316), is urged, by the plunger 308, in the uphole direction.

As depicted in FIG. 2C, the pump 300 is configurable in an uphole-disposed movement reversal configuration. In the uphole-disposed movement reversal configuration, the traveling valve 306 is closed, and the standing valve 310 is closed. In the uphole-disposed movement reversal configuration, the traveling valve 306 is disposed uphole relative to its position in the downhole-disposed movement reversal configuration, and the volume of the pump cavity 312 is larger relative to its volume in the downhole-disposed movement reversal configuration.

In some embodiments, for example, the pump 300 is transitionable from the pump cavity-filling configuration (FIG. 2B) to the uphole-disposed movement reversal configuration (FIG. 2C). In some of these embodiments, for example, the transitioning is effectible while the conveyor 302 is being displaced uphole.

While the pump 300 is disposed in the pump cavity-filling configuration and the conveyor 304 is being displaced uphole, the conveyer 302 continues to be displaced uphole until the conveyer 302 has reached an uphole displacement limit as defined by the surface equipment, such that further uphole displacement of the traveling valve 306 relative to the standing valve 310 is prevented. In response to the suspension of the uphole displacement of the conveyer 302, fluid, disposed immediately downhole of the standing valve 306 (e.g. within the space 314), becomes disposed in fluid pressure equilibrium with fluid disposed within the pump cavity 312, such that there is an absence of a pressure differential across the closure member 3106. As a result, the closure member 3106 becomes seated on the seat 3104 due to the force of gravity applied to the closure member 3106, and flow of reservoir fluid through the standing valve 310 is prevented. Meanwhile, the travelling valve 306 remains closed during the transitioning of the pump 300 from the pump cavity-filling configuration to the uphole-disposed movement reversal configuration.

In some embodiments, for example, the pump 300 is transitionable from the uphole-disposed movement reversal configuration (FIG. 2C) to the pump cavity-evacuation configuration (FIG. 2D) in response to displacement of the conveyer 302 in the downhole direction. In the pump cavity-evacuation configuration, the travelling valve 306 is open and the standing valve 310 is closed.

While the pump 300 is disposed in the uphole-disposed movement reversal configuration, the conveyer 302 is displaceable downhole, and, in response to the downhole displacement of the conveyor 302, the transitioning of the pump 300 from the uphole-disposed movement reversal configuration to the pump cavity-evacuation configuration is effected.

In this respect, while the sucker rod pumping system 150 is emplaced within the wellbore 102 such that the pump 300 is disposed in the uphole-disposed movement reversal configuration, in response to the conveyer 302 being displaced in a downhole direction such that the travelling valve 306 is displaced towards the standing valve 310 with effect that volume of the pump cavity 312 becomes reduced, and fluid pressure within the pump cavity 312 is being increased such that a sufficiently high opening pressure is established within the pump cavity 312. At this point, a sufficiently high opening pressure differential is being established across the closure member 3066 of the traveling valve 306, between the pump cavity 312 and space 316 disposed immediately uphole relative to the traveling valve 306 (and disposed within the reservoir fluid conductor 202). The sufficiently high opening pressure differential is established by fluid pressure communication, to the closure member 3066, of a fluid pressure, of fluid that is disposed within the pump cavity 312, which exceeds fluid pressure of fluid disposed within the space 316 immediately uphole of the closure member 3066. As a result, the fluid within the pump cavity 312 urges unseating of the closure member 3066 from the valve seat 3064, thereby effecting opening of the travelling valve 306, and the fluid within the pump cavity 312 is displaced from the pump cavity 312, through the traveling valve 306, and becomes displaced within the reservoir fluid conductor 202, immediately uphole relative to the travelling valve 306.

Meanwhile, while the conveyer 302 is displacing in a downhole direction to displace the traveling valve 306 towards the standing valve 310, with effect that volume of the pump cavity 312 is being decreased and pressure within the pump cavity 312 is being increased, a sufficient closing pressure differential remains established across the closure member 3106 of the standing valve 310, between the pump cavity 312 and the downhole flow receiving communicator 314. In this respect, fluid pressure, of fluid within the pump cavity 312, sufficiently exceeds the pressure of fluid disposed immediately downhole of the standing valve 310, such that an effective closing pressure differential is established across the closure member 3106 of the standing valve 310. In response to the effective closing pressure differential, and, in combination with gravitational forces, the closure member 3106, which is seated on the seat 3104, is urged to remain seated on the valve seat 3104, such that the traveling valve 306 remains closed, and flow of reservoir fluid through the traveling valve 306 is prevented.

In this respect, in some embodiments, for example, the plunger 308, the traveling valve 306, the standing valve 310, and the pump cavity 312 are co-operatively configured such that, in response to downhole displacement of the plunger 308: (i) the standing valve 310 is urged to remain closed, and (ii) the traveling valve 306 is urged to open, with effect that at least a portion of the fluid within the pump cavity 312 is displaced from the pump cavity 312, with effect that the displaced fluid becomes disposed uphole relative to the travelling valve 306.

While the conveyor 302 continues to be displaced in a downhole direction such that the travelling valve 306 is further displaced towards the standing valve 310, the closure member 3066 of the traveling valve 306, which is unseated from the seat 3064, is urged to remain unseated from the valve seat 3064, such that the traveling valve 306 remains open, and fluid within the pump cavity 312 continues to be displaced from the pump cavity 312, through the traveling valve 306, and become disposed immediately uphole relative to the traveling valve 306.

Meanwhile, while the conveyer 302 is being displaced in the downhole direction, such that the traveling valve 306 is being displaced towards the standing valve 310, an effective closing pressure differential remains established across the closure member 3106 of the standing valve 310. In this respect, fluid pressure, of fluid within the pump cavity 312, continues to sufficiently exceed the pressure of fluid disposed immediately downhole relative to the standing valve, such that an effective closing pressure differential is established across the closure member 3106 of the standing valve 310. In response to the effective closing pressure differential, and, in combination with gravitational forces, the closure member 3106, which is seated on the seat 3104, is urged to remain seated on the valve seat 3104, such that the standing valve 310 remains closed, and flow of reservoir fluid through the standing valve 310 is prevented.

In some embodiments, for example, the pump 300 is transitionable from the pump cavity-evacuation configuration (FIG. 2D) to the downhole-disposed movement reversal configuration (FIG. 2A). In some of these embodiments, for example, the transitioning is effectible while the conveyor 302 is being displaced downhole.

While the pump 300 is disposed in the pump cavity-evacuation configuration and the conveyor 302 is being displaced downhole, the conveyer 302 continues to be displaced downhole until the conveyer 302 has reached a downhole displacement limit as defined by the surface equipment, such that further downhole displacement of the traveling valve 306 relative to the standing valve 310 is prevented. In response to the suspension of the downhole displacement of the conveyer 302, fluid, disposed immediately uphole of the traveling valve 310 (e.g. within the space 316), becomes disposed in fluid pressure equilibrium with fluid disposed within the pump cavity 312, such that there is an absence of a pressure differential across the closure member 3066. As a result, the closure member 3066 becomes seated on the seat 3064 due to the force of gravity applied to the closure member 3066, and flow of reservoir fluid through the traveling valve 306 is prevented. Meanwhile, the standing valve 310 remains closed during the transitioning of the pump 300 from the pump cavity-evacuation configuration to the downhole-disposed movement reversal configuration.

The sequence described in FIGS. 2A to 2D defines a cycle which is repeated, and the pump 300 continues to progressively pump reservoir fluid uphole towards the surface 106 with each successive cycle.

In some embodiments, for example, as reservoir fluid flows into the pump 300 via the open standing valve 310, the closure member 3106 of the standing valve 310 is lifted from its seat 3104, and is free to displace, especially laterally, within the standing valve 310. Such displacement of the closure member 3106 of the standing valve 310, or valve chatter, may cause wear and tear or damage to the standing valve 310, such as the valve body, the closure member, the seat, or other components of the standing valve 310. Similarly, in some embodiments, for example, as reservoir fluid flows into the pump 300 via the open traveling valve 306, the closure member 3066 of the traveling valve 306 is lifted from its seat 3064, and is free to displace, especially laterally, within the traveling valve 306. Such displacement of the closure member 3066 of the traveling valve 306, or valve chatter, may cause wear and tear or damage to the traveling valve 306, such as the valve body, the ball, the seat, or other components of the traveling valve 306.

In this respect, for at least the purpose of mitigating such damage, in some embodiments, for example, the system 10 can be modified with a torsional flow-inducing adapter 600. In some embodiments, for example, the torsional flow-inducing adapter 600 is connectible to the reservoir fluid supplying conductor 202 such that the adapter becomes emplaced within the reservoir fluid supplying conductor 202. In some embodiments, for example, where the torsional flow-inducing adapter 600 is emplaced within the reservoir fluid supplying conductor 202, the torsional flow-inducing adapter 600 is emplaced downhole of a seat of a valve (such as a standing valve 310 or a travelling valve 306, or separate adapters for each one of standing valve 310 and the travelling valve 306).

In some embodiments, for example, the reservoir fluid-supplying conductor 202 defines a conductor flow receiver 204, wherein the reservoir fluid-supplying conductor 202 receives reservoir fluid via the conductor flow receiver 204. The conductor flow receiver 204 is for receiving, via the wellbore, the reservoir fluid flow from the reservoir 104. In this respect, the reservoir fluid flow enters the wellbore 102, as described above, and is then conducted to the conductor flow receiver 204. In some embodiments, for example, the torsional flow-inducing adapter 600 is disposed within the conductor 202 such that, while reservoir fluid is being received by the conductor flow receiver 204, such that reservoir fluid is being conducted through the conductor 202 and across the adapter 600, the adapter 600 interacts with the conducted reservoir fluid such that torsional flow of the reservoir fluid is generated. In some of these embodiments, for example, the generation of the torsional flow is effected in response to imparting of a torsional flow component to the conducted reservoir fluid by the adapter 600.

In some embodiments, for example, it is preferable to reduce or mitigate displacement, for example, lateral and longitudinal displacement, of the closure member of a valve of the pump 300, for example, a standing valve 310 or a traveling valve 306, during operation of the pump 300, in order to reduce wear and tear or damage to the valve, such that, for example, frequency of maintenance of the valve may be reduced. In some embodiments, for example, it is preferable to reduce pressure drop across the closure member, which mitigates release of gas from the reservoir fluid, thereby causing pump interference, which would otherwise happen if a larger pressure differential were established. In some embodiments, for example, it is preferable to reduce foam generation and solution gas liberation, which, in some embodiments, increases pump gas interference. The torsional flow-inducing adapter 600 is provided to, amongst other things, to perform these functions.

In some embodiments, for example, as depicted in FIG. 3 and FIG. 4, the torsional flow-inducing adapter 600 includes a body 600A. The body 600A includes a reservoir fluid receiver 602 for receiving the reservoir fluid (such as, for example, in the form of a reservoir fluid flow) that is being conducted (e.g. flowed), via the reservoir fluid-supplying conductor 202, from the conductor flow receiver 204. In this respect, the inlet 204 and the reservoir fluid receiver 602 are disposed in fluid communication. The body 600A also includes a reservoir fluid discharge communicator 604 and a reservoir fluid conductor 603, wherein the reservoir fluid discharge communicator 604 is fluidly coupled to the reservoir fluid receiver 602 via the reservoir fluid conductor 603. The reservoir fluid discharge communicator 604 is configured for discharging reservoir fluid (such as, for example, in the form of a flow) that is received by the reservoir fluid receiver 602 and conducted to the reservoir fluid discharge communicator 604 via the reservoir fluid conductor 603. In some embodiments, for example, the reservoir fluid discharge communicator 604 is disposed at an opposite end of the body 600A relative to the reservoir fluid receiver 602, as depicted in FIG. 3.

As depicted in FIG. 3 and FIG. 4, in some embodiments, for example, the torsional flow-inducing adapter 600 includes an internal surface 606B that defines the reservoir fluid conductor 603 for conducting the reservoir fluid that is received by the inlet 204 and by the reservoir fluid receiver 602. In some embodiments, for example, at least a portion of the internal surface 606B defines a contoured surface 606C. The contoured surface 606C is contoured with effect that, while reservoir fluid is being conducted through the reservoir fluid conductor 603 and past the contoured surface 606C, the contoured surface 606C interacts with at least a portion of the conducted reservoir fluid such that torsional flow is induced by the contoured surface 606C, with effect that at least a portion of the fluid flow conducted through the flow communicator of the valve (e.g. valve 310 or valve 306) is a torsional fluid flow.

In some embodiments, for example, the surface 606B includes two or more spaced-apart contoured surfaces 606C. The contoured surfaces 606C are co-operatively disposed such that a desired torsional flow condition is effectible within the reservoir fluid conductor 603.

In some embodiments, for example, the torsional flow rotates about the central longitudinal axis 606D of the reservoir fluid conductor 603.

In some embodiments, for example, the contoured surface 606C defined by the internal surface 606B is defined by a rifled groove, such as, for example, a helical rifled groove. In some embodiments, for example, the rifled groove has a minimum depth of at least 0.1 cm. In some embodiments, for example, the pitch of the rifled groove is between 30 degrees to 60 degrees, such as, for example, between 40 degrees and 55 degrees.

In some embodiments, for example, the contouring is defined by a plurality of spaced apart vanes extending into the reservoir fluid conductor 603.

In some embodiments, for example, as depicted in FIG. 3, the contoured surface 606C of the torsional flow-inducing adapter 600 includes a rifled surface.

In some embodiments, for example, the at least a portion of the torsional flow-inducing adapter 600, whose internal surface 606B defines the contoured surface 606C, defines at least 10% (such as, for example, at least 25%, such as, for example, at least 50%) of the total length of the reservoir fluid conductor 603 as measured along the central longitudinal axis 606D of the reservoir fluid conductor 603. In some embodiments, for example, the contoured surface 606C has a length of at least 1 foot, for example, 10 feet, as measured along the central longitudinal axis of the reservoir fluid conductor 603. In some embodiments, for example, the contoured surface 606C has a length of at least 25 feet, as measured along the central longitudinal axis of the reservoir fluid conductor 603. In some embodiments, for example, the contoured surface 606C has a length of at least 50 feet as measured along the central longitudinal axis of the reservoir fluid conductor 603. In some embodiments, for example, the contoured surface 606C has a length of at least 100 feet as measured along the central longitudinal axis of the reservoir fluid conductor 603.

It is desirable to avoid slug flow through the reservoir fluid-supplying conductor 202, as this results in liquid loading. Liquid loading reduces recovery from the well.

In some embodiments, for example, by the inducing of the torsional flow, via the adapter 600, of the reservoir fluid that flows through a valve (such as, for example, a standing valve 310 or a traveling valve 306) lateral displacement of the ball of the closure member is reduced or mitigated, such that wear and tear or damage to the valve due to collision of the closure member and other components of the valve is reduced. In some embodiments, for example, by the inducing of the torsional flow via the torsional flow-inducing adapter 600, pressure drop across the closure member is reduced, which mitigates release of gas from the reservoir fluid, thereby causing pump interference, which would otherwise happen if a larger pressure differential were established. In some embodiments, for example, by the inducing of the torsional flow via the torsional flow-inducing adapter 600, slug flow through the reservoir fluid-supplying conductor 202 is avoided, thereby reducing or mitigating liquid loading. In some embodiments, for example, by the generating of the torsional flow via the torsional flow-inducing adapter 600, foam generation and solution gas liberation is reduced or mitigated, which, in some embodiments, decreases pump gas interference.

In some embodiments, for example, during operation of a pump 300 in the reservoir fluid supplying conductor 202 to produce reservoir fluid in which a valve of the pump 300 opens, there is an immediate and rapid pressure reduction upstream of said valve. Such pressure reduction may promote liberation of solution gas, which tends to promote scale formation and corrosion.

In some embodiments, for example, the contoured surface 606C has non-stick properties, in order to reduce or avoid scale adhesion and to reduce or avoid corrosion. In some embodiments, for example, the contoured surface 606C is defined by composite non-metal material such as, for example, a polymeric material, such as onyx, in order to reduce or avoid scale adhesion and to reduce or avoid corrosion. In some embodiments, for example, onyx is a chopped carbon reinforced nylon. In some embodiments, for example, onyx is stronger and stiffer, for example, 1.4 times stronger and stiffer, than acrylonitrile butadiene styrene, and is reinforceable with a continuous fiber. In some embodiments, for example, manufacturing the contoured surface 606C with onyx improves its surface finish, chemical resistivity, and heat tolerance.

In some embodiments, for example, where the contoured surface 606C is defined by onyx, the onyx in reinforceable with high strength, high temperature fibreglass.

In some embodiments, for example, the contoured surface 606C is defined by a polymeric material liner, such that the contoured surface 606C is lined with polymeric material, and such that the contoured surface 606C is defined by a polymeric material-lined fluid conductor. By integrating the polymeric material liner, standard tubing (configured according to specifications the American Petroleum Institute (“API”)) can be used for the torsional flow-inducing adapter 600, and the cross-sectional flow of the standard tubing is attenuated by the liner to facilitate flow of the reservoir fluid at a desired speed. In this respect, in some embodiments, for example, the contouring is of the polymeric material liner. In some embodiments, for example, the polymeric material includes plastic material.

In some embodiments, for example, a sucker rod pump 300, disposed within a wellbore 102, is retrofit with a torsional flow-inducing adapter 600. In some embodiments, for example, the pump 300 is retrieved from the wellbore 102, and the torsional flow-inducing adapter 600 is connected to the pump 300, such as to the standing valve 310 or the traveling valve 306 of a rod pump, such that torsional-flowing reservoir fluid is conductible to the standing valve 310 or the traveling valve 306. The modified pump is deployed downhole and operated to produce reservoir fluids.

A method of coupling a torsional flow-inducing adapter 600 to a rod pump 300 disposed within a wellbore 102, wherein the rod pump 300 includes a standing valve 310 and a travelling valve 306, comprises: retrieving the rod pump 300 from a wellbore 102, for at least one of the standing valve 310 and the travelling valve 306, connecting a respective torsional flow-inducing adapter 600 to each one of the at least one of the standing valve 310 and the travelling valve 306 such that a modified rod pump 300 is obtained including at least one torsional flow-inducing adapter 600, wherein each one of the at least one torsional flow-inducing adapter 600, independently, is disposed in flow communication with a respective one of the standing valve 310 and the travelling valve 306, such that for each one of the at least one torsional flow-inducing adapter 600, independently, the torsional flow-inducing adapter 600 is configured for inducing torsional flow to reservoir fluid being conducted, via the torsional flow-inducing adapter 600, to the respective one of the standing valve 310 and the travelling valve 306, and deploying the modified rod pump 300 within the wellbore 102.

In some of these embodiments, for example, the torsional flow-inducing adapter 600 is connected upstream of the standing valve 310 of the sucker rod pump 300. In some embodiments, for example, the connection between the torsional flow-inducing adapter 600 and the standing valve 310 is a threaded connection. In some embodiments, for example, the connection between the torsional flow-inducing adapter 600 and the standing valve 310 is an interference fit connection.

In some of these embodiments, for example, the torsional flow-inducing adapter 600 is connected upstream of the travelling valve 306 of the sucker rod pump 300, within a space between the traveling valve 306 and the standing valve 310, of the sucker rod pump. In some embodiments, for example, the adapter 600 is connected to the plug seat. In some embodiments, for example, the connection between the torsional flow-inducing adapter 600 and the traveling valve is a threaded connection. In some embodiments, for example, the connection between the torsional flow-inducing adapter 600 and the traveling valve 306 is an interference fit connection.

Once the torsional flow-inducing adapter 600 is connected to the system 10, the system 10 is modified such that a modified system 10 is provided which further comprises a torsional flow inducer (defined by the connected torsional flow-inducing adapter 600).

In some embodiments, for example, the torsional flow inducer is originally part of the system 10, and is not retrofitted to an existing system that is disposed within a wellbore 102, such that a system is provided including the torsional flow inducer (having identical features to the adapter 600).

In some embodiments, for example, the flow communicator of a valve of pump 300 (such as a standing valve 310 or a traveling valve 306), and the torsional flow inducer, are disposed in fluid communication via a fluid passage of a fluid conductor (such as, for example, a portion of the fluid conductor 302). The fluid passage has a central longitudinal axis, and the distance between the contoured surface and the flow communicator, as measured along the central longitudinal axis, is such that decay of the generated torsional flow is reduced or mitigated. In this respect, in some embodiments, for example, this distance is less than ten (10) inches. In some embodiments, for example, the distance between the contoured surface 606C and the flow communicator of the valve, measured along the central longitudinal axis, is less than 68 times the internal diameter of the fluid conductor.

In operation, as the pump 300 of the system 10 is operated via reciprocating longitudinal displacement of the sucker rod 302 for producing reservoir fluid from the reservoir 104 disposed within the subterranean formation 100, the reservoir fluid of the reservoir 104 flows into the conductor flow receiver 204 of the reservoir fluid-supplying conductor 202. The reservoir fluid is conducted to the torsional flow inducer via the reservoir fluid-supplying conductor 202, and flows into the torsional flow inducer via the reservoir fluid receiver 602. While the reservoir fluid is flowing across the contoured surface 606C of the torsional flow inducer, for at least a portion of the reservoir fluid flow being conducted past the contoured surface 606C, torsional flow is induced by the contoured surface 606C, with effect that at least a portion of the fluid flow conducted through the flow communicator, and past the closure member, as a torsional fluid flow.

FIGS. 5 to 9 depict an alternate embodiment of a torsional flow-inducing adapter 1200. In some embodiments, for example, the torsional flow-inducing adapter 1200 is configured to be disposed downhole of, and connected to, a standing valve 310. As depicted in FIGS. 5 to 9, in some embodiments, for example, the torsional flow-inducing adapter 1200 includes a torsional flow-inducing insert 1210. In some embodiments, for example, the torsional flow-inducing adapter 1200 further comprises a strainer 700 and a coupling 504 that is configured to couple the torsional flow-inducing insert torsional flow-inducing insert 1210 and the strainer 700. In some embodiments, for example, the torsional flow-inducing insert 1210 has a body 1200A, a reservoir fluid receiver 1202, a reservoir fluid conductor 1203, a reservoir fluid discharge communicator 1204, an internal surface 1206B, wherein at least a section of the torsional flow-inducing insert 1210 defines a contoured surface 1206C, similar to the body 600A, a reservoir fluid receiver 602, a reservoir fluid conductor 603, a reservoir fluid discharge communicator 604, the internal surface 606B, and the contoured surface 606C as described herein with respect to the torsional flow-inducing adapter 600 as depicted in FIG. 3 and FIG. 4. As depicted, the torsional flow-inducing insert 1210 includes the passage defining surface 1206B and the contoured surface 1206C that is contoured with rifling. In some embodiments, for example, the contoured 1206C is defined on an internal surface of the torsional flow-inducing insert 1210. In some embodiments, for example, the internal surface of the torsional flow-inducing insert 1210 is a cylindrical surface of the torsional flow-inducing insert 1210 having an inner diameter. In some embodiments, for example, the torsional flow-inducing insert 1210 is receivable in the coupling 504, which is connectible with the strainer 700, for example, via threads, interference fit, friction fit, and the like. In some embodiments, for example, the connection between the torsional flow-inducing adapter 1200 and the standing valve 310 is a threadable connection.

FIG. 7 depicts an example embodiment of the torsional flow-inducing adapter 1200.

FIG. 8 depicts a torsional flow 506 that is generated by the torsional flow-inducing adapter 1200.

FIG. 9 depicts the pump 300 seated on a seating nipple 210 via a hold-down 318, with the torsional flow-inducing adapter 1200 connected to the standing valve 310.

In some embodiments, for example, at least a portion of the torsional flow-inducing insert 1210, for example, the contoured surface 1206C of the torsional flow-inducing insert 1210, has non-stick properties, in order to reduce or avoid scale adhesion and to reduce or avoid corrosion. In some embodiments, for example, at least a portion of the torsional flow-inducing insert 1210, for example, the contoured surface 1206C of the torsional flow-inducing insert 1210 is defined by composite non-metal material such as, for example, a polymeric material, such as onyx, in order to reduce or avoid scale adhesion and to reduce or avoid corrosion. In some embodiments, for example, onyx is a chopped carbon reinforced nylon. In some embodiments, for example, manufacturing the contoured surface 1206C of the torsional flow-inducing insert 1210 with onyx improves its surface finish, chemical resistivity, and heat tolerance.

In some embodiments, for example, wherein at least a portion of the torsional flow-inducing insert 1210, for example, the contoured surface 1206C, is manufactured with onyx, the onyx in reinforceable with high strength, high temperature fibreglass.

In some embodiments, for example, the strainer 700 is coated with MAC100+®, a metallic alloy composite coating manufactured by Pro-Pipe Service and Sales Ltd., in order to reduce or avoid scale adhesion and to reduce or avoid corrosion.

FIGS. 10 to 19 depict an alternate embodiment of the torsional flow-inducing adapter 1200 that is configured to be disposed downhole of, and connected to, a standing valve 310. As depicted, the torsional flow-inducing adapter 1200 includes a torsional flow-inducing insert 1210 that is receivable inside an existing rod pumping component, for example, receivable inside the inner diameter of an existing rod pumping component. As depicted, the torsional flow-inducing adapter 1200 further comprises a strainer 700, and the torsional flow-inducing insert 1210 is receivable in the strainer 700.

FIG. 10 and FIG. 11 depict embodiments of the strainer 700.

As depicted in FIG. 11, the strainer 700 includes one or more ports 702 for receiving reservoir fluid from the wellbore 102. The strainer 700 further includes a connector 704 to connect with the standing valve 310. As depicted, in some embodiments, for example, the connector 704 includes threading. In some embodiments, for example, the strainer 700 further defines a shoulder 706 for supporting a corresponding shoulder 1220 of the torsional flow-inducing insert 1210 as the torsional flow-inducing insert 1210 is received in the strainer 700, as depicted in FIG. 13.

FIG. 14 depicts two strainers 700 that are each, independently, configured to receive a torsional flow-inducing insert 1210.

FIG. 15 depicts an embodiment of the torsional flow-inducing insert 1210. As depicted, in some embodiments, for example, the torsional flow-inducing insert 1210 includes an internal truss structure 1212 to provide structural strength for the torsional flow-inducing insert 1210.

FIG. 16 depicts an embodiment of a strainer 700, and FIGS. 17 and 18 depict an embodiment of a torsional flow-inducing insert 1210. FIG. 19 depicts an embodiment of a torsional flow-inducing adapter 1200, wherein the torsional flow-inducing insert 1210 is received in the strainer 700.

In some embodiments, for example, the system includes a tubing pump, and a torsional flow inducer is originally installed with the system in association with one or both of the travelling valve and the standing valve of the tubing pump. In some embodiments, for example, an existing system, including a tubing pump, is disposed downhole, and the traveling valve of such a system could be retrofitted with the adapter 600 such that a modified plunger, including the adapter 600, is provided.

FIG. 20 depicts an embodiment of a float collar 1600, for example, a non-rotating float collar 1600. In some embodiments, for example, the float collar 1600 is disposed proximate the downhole end of the casing string, for example, one to three joints uphole from the downhole end of the casing string. The float collar 1600, in some embodiments, for example, includes a valve 1602, such as a check valve, and a head 1604, such as a non-rotating female head, on which a valve plug may be received. In some embodiments, for example, the valve 1602 is a poppet-style valve. The valve 1602 resists backwards flow of slurry during the cementing process of a wellbore casing string.

FIG. 21 depicts an embodiment of a float shoe 1700. In some embodiments, for example, the float shoe 1700 is disposed at the downhole end of the casing string. The float shoe 1700, in some embodiments, for example, includes a valve 1702, such as a check valve 1702. In some embodiments, for example, the valve 1702 is a poppet-style valve. The valve 1702 resists backwards flow of slurry during the cementing process of a wellbore casing string.

In some embodiments, for example, the float collar 1600 and the float shoe 1700 are used as part of the cementing process of a wellbore casing string.

In some embodiments, for example, the torsional flow-inducing adapter 600 as described herein is emplaceable upstream, for example, uphole, of the valve seat of the valve 1602 of the float collar 1600 or the valve 1702 of the float shoe 1700, as depicted in FIG. 20 and FIG. 21. In some embodiments, for example, the torsional flow-inducing adapter 600 is connected to the float collar 1600 or the float shoe 1700, for example, the valve 1602 of the float collar 1600 or the valve 1702 of the float shoe 1700, via threaded connection or interference fit connection. In some embodiments, for example, by disposing the torsional flow-inducing adapter 600 upstream of the float collar 1600 or the float shoe 1700 to generate torsional flow that is conducted to the valve 1602 of the float collar 1600 or the valve 1702 of the float shoe 1700, in some embodiments, for example, failure of the valve is reduced or mitigated, and pressure drop through the valve is reduced or mitigated, such that cementing is more efficient and effective.

In some embodiments, for example, the standing valve of a sucker rod pump is defined by a standing valve assembly 1800 having more than one valve, for example, two valves 1802, 1804, with the valve 1802 disposed downhole relative to the valve 1804, as depicted in FIG. 22 and FIG. 23. In some embodiments, for example, the torsional flow-inducing adapter 1200 is configured to be disposed upstream of, or downhole of, the valve 1802, as depicted in FIG. 22. In some embodiments, for example, the torsional flow-inducing adapter 1200 is configured to be connected to the valve 1802, for example, via threaded connection. In some embodiments, for example, the torsional flow-inducing adapter 1200 is configured to be disposed upstream of, or downhole of, the valve 1804, and also between the valve 1802 and the valve 1804, as depicted in FIG. 23. In some embodiments, for example, the torsional flow-inducing adapter 1200 is configured to be connected to the valve 1804, for example, via threaded connection.

In some embodiments, for example, the traveling valve of a sucker rod pump is defined by a traveling valve assembly 2000 having more than one valve, for example, two valves 2002, 2004, with the valve 2002 disposed downhole relative to the valve 2004, as depicted in FIG. 24 and FIG. 25. In some embodiments, for example, the torsional flow-inducing adapter 1200 is configured to be disposed upstream of, or downhole of, the valve 2002, as depicted in FIG. 24. In some embodiments, for example, the torsional flow-inducing adapter 1200 is configured to be connected to the valve 2002, for example, via interference fit connection. In some embodiments, for example, the torsional flow-inducing adapter 1200 is configured to be disposed upstream of, or downhole of, the valve 2004, and also between the valve 2002 and the valve 2004, as depicted in FIG. 25. In some embodiments, for example, the torsional flow-inducing adapter 600 is configured to be connected to the valve 2004, for example, via interference fit connection.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1-40. (canceled)

41. A torsional flow-inducing adapter configured for connection to a downhole valve disposed within a wellbore, wherein the downhole valve includes:
a valve body defining a flow communicator and a seat; and
a closure member;
wherein:
the closure member, the flow communicator, and the seat are co-operatively configured such that, while the closure member is seated on the seat, the flow communicator is occluded by the closure member; and
the closure member, the flow communicator, and the seat are co-operatively configured such that, while the closure member is seated on the seat, the closure member is displaceable uphole relative to the seat with effect that:
(i) the closure member is unseated relative to the seat;
(ii) fluid flow is conductible through the flow communicator; and
(iii) while fluid flow is being conducted through the flow communicator, the closure member is obstructive to the conducted fluid flow, with effect that at least a portion of the conducted fluid flow is diverted past the closure member;
wherein:
the torsional flow-inducing adapter defines a contoured surface; and
the torsional flow-inducing adapter is configured to co-operate with the valve such that, while the torsional flow-inducing adapter is connected to the valve, the contoured surface is disposed downhole relative to the valve seat, such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.

42. The adapter of claim 41;
wherein:
the closure member, the flow communicator, and the seat are co-operatively configured such that, while the closure member is seated on the seat, the closure member is responsive to establishing of a fluid pressure differential across the closure member for displacement relative to the valve seat for becoming unseated from the valve seat, wherein the fluid pressure differential is established by fluid pressure communication, to the closure member, of an uphole fluid pressure of fluid that is disposed uphole relative to the closure member, and fluid pressure communication, to the closure member, of a downhole fluid pressure of fluid that is disposed downhole relative to the valve, wherein the downhole fluid pressure exceeds the uphole fluid pressure;

43. The adapter of claim 41, wherein:
the torsional flow-inducing adapter is configured to co-operate with the valve such that, while the torsional flow-inducing adapter is connected to the valve:
the contoured surface defines a fluid passage-defining surface for defining at least a portion of the outermost perimeter of a downhole fluid passage for supplying fluid flow to the valve; and
while the closure member is unseated from the valve seat, fluid flow is conductible through the flow communicator via the downhole fluid passage.

44. The adapter of claim 41;
wherein:
the valve is a valve of a rod pump.

45. The adapter of claim 41;
wherein:
the contoured surface is defined by a rifled groove.

46. The adapter of claim 45;
wherein:
the rifled groove has a minimum depth of at least 0.1 cm.

47. The adapter of claim 45:
wherein:
the pitch of the rifled groove is from 30 degrees to 60 degrees.

48. A system for producing reservoir fluids from a reservoir disposed within a subterranean formation, the system comprising:
a valve body defining a flow communicator and a seat;
a closure member;
a torsional flow inducer, connected to the seat and disposed downhole relative to the seat, and defining a contoured surface;
wherein:
the closure member, the flow communicator, and the seat are co-operatively configured such that, while the closure member is seated on the seat, the flow communicator is occluded by the closure member; and
the closure member, the flow communicator, and the seat are co-operatively configured such that, while the closure member is seated on the seat, the closure member is displaceable uphole relative to the seat with effect that:
(i) the closure member is unseated relative to the seat;
(ii) fluid flow is conductible through the flow communicator; and
(iii) while fluid flow is being conducted through the flow communicator, the closure member is obstructive to the conducted fluid flow, with effect that at least a portion of the conducted fluid flow is diverted past the closure member;
and
the torsional flow-inducer co-operates with the valve such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.

49. The system of claim 48;
wherein:
the closure member, the flow communicator, and the seat are co-operatively configured such that, while the closure member is seated on the seat, the closure member is responsive to establishing of a fluid pressure differential across the closure member for displacement relative to the valve seat for becoming unseated from the valve seat, wherein the fluid pressure differential is established by fluid pressure communication, to the closure member, of an uphole fluid pressure of fluid that is disposed uphole relative to the closure member, and fluid pressure communication, to the closure member, of a downhole fluid pressure of fluid that is disposed downhole relative to the valve, wherein the downhole fluid pressure exceeds the uphole fluid pressure.

50. The system of claim 48;
wherein:
the valve is a valve of a rod pump.

51. The system of claim 48;
wherein:
the contoured surface is defined by a rifled groove.

52. The system of claim 51;
wherein:
the rifled groove has a minimum depth of at least 0.1 cm.

53. The system of claim 51:
wherein:
the pitch of the rifled groove is from 30 degrees to 60 degrees.

54. The system of claim 48;
wherein:
the torsional flow inducer and the flow communicator of the valve are disposed in fluid communication via a fluid passage;
the fluid passage has a central longitudinal axis; and
the distance between the contoured surface and the flow communicator, as measured along the central longitudinal axis, is less than ten (10) inches.

55. The system of claim 48;
further comprising:
a fluid conductor defining a fluid passage for conducting reservoir fluid from the torsional flow inducer to the flow communicator;
the fluid passage has a central longitudinal axis; and
the distance between the contoured surface and the flow communicator, measured along the central longitudinal axis, is less than 68 times the internal diameter of the fluid conductor.

56. A method of coupling a torsional flow inducing adapter to a rod pump disposed within a wellbore, wherein the rod pump includes a standing valve and a travelling valve, comprising:
retrieving the rod pump from a wellbore;
for at least one of the standing valve and the travelling valve, connecting a respective torsional flow inducing adapter to each one of the at least one of the standing valve and the travelling valve such that a modified rod pump is obtained including at least one torsional flow inducing adapter, wherein each one of the at least one torsional flow inducing adapter, independently, is disposed in flow communication with a respective one of the standing valve and the travelling valve, such that for each one of the at least one torsional flow inducing adapter, independently, the torsional flow inducing adapter is configured for inducing torsional flow to reservoir fluid being conducted, via the torsional flow inducing adapter, to the respective one of the standing valve and the travelling valve; and
deploying the modified rod pump within the wellbore.

57. The method of claim 56, wherein:
for each one of the at least one torsional flow inducing adapter, the torsional flow inducing adapter defines a fluid-passage defining surface which defines a fluid passage;
the conducting of the reservoir fluid is effected via the fluid passage;
the fluid-passage defining surface is contoured for effecting the inducing of the torsional flow; and
the contouring is defined by a rifled groove.

58. The method of claim 56, wherein the rifled groove has a minimum depth of at least 0.1 cm.

59. The method of claim 56, wherein the pitch of the rifled groove is from 30 degrees to 60 degrees.

60. A system for producing reservoir fluids from a reservoir disposed within a subterranean formation, the system comprising:
a rod pump including a traveling valve and a standing valve, wherein the standing valve includes:
a valve body defining a flow communicator and a seat; and
a closure member;
and
a torsional flow inducer, disposed downhole relative to the seat, and defining a contoured surface;
wherein:
the closure member, the flow communicator, and the seat are co-operatively configured such that, while the closure member is seated on the seat, the flow communicator is occluded by the closure member; and
the closure member, the flow communicator, and the seat are co-operatively configured such that, while the closure member is seated on the seat, the closure member is displaceable uphole relative to the seat with effect that:
(i) the closure member is unseated relative to the seat;
(ii) fluid flow is conductible through the flow communicator; and
(iii) while fluid flow is being conducted through the flow communicator, the closure member is obstructive to the conducted fluid flow, with effect that at least a portion of the conducted fluid flow is diverted past the closure member;
and
the torsional flow inducer co-operates with the standing valve such that, while the closure member is unseated from the valve seat and fluid flow is being conducted past the contoured surface, for at least a portion of the fluid flow being conducted past the contoured surface, torsional flow is induced by the contoured surface, with effect that at least a portion of the fluid flow conducted through the flow communicator is a torsional fluid flow.
